(19) United States
(12) Patent Application Publication
(10) Pub. No.: US 2007/0193341 A1
(43) Pub. Date: Aug. 23, 2007

(54) Testing Device for Detecting Vapor Emission of at Least One Leakage Point, Especially of a Mechanical Shaft Seal, Particularly in the Automotive Field

(75) Inventors: Tobias Hoffmann, Bad Rappenau (DE); Eckhard Ogaza, Obersulm (DE); Gerhard Gwinner, Heilbronn (DE)

Correspondence Address: GUDRUN E. HUCKETT DRAUDT, SCHUBERTSTR. 15A, WUPPERTAL, 42289, DE

(73) Assignee: KACO GMBH & CO. KG, Heilbronn (DE)

(21) Appl. No.: 11/675,642

(22) Filed: Feb. 16, 2007

(30) Foreign Application Priority Data
Feb. 17, 2006 (DE) 10 2006 008 463.2

(51) Int. Cl. G01M 3/28; G01M 3/18

(52) U.S. Cl. 73/46; 73/40

(57) ABSTRACT

A testing device for detecting vapor emission of at least one leakage point has at least one upstream measuring unit arranged upstream of the leakage point and at least one downstream measuring unit arranged downstream of the leakage point. The at least one upstream and the at least one downstream measuring units are connected serially. The at least one upstream measuring unit determines measured values of a reference stream and the at least one downstream measuring unit determines measured values of the reference stream plus a vapor emission of the leakage point. By comparing the measured values, the humidity quantity and thus the vapor emission at the leakage point can be determined.

### BACKGROUND OF THE INVENTION

The invention relates to a testing device for detecting vapor emission of at least one leakage point, especially of mechanical shaft seals, particularly in the automotive field. The testing device comprises at least one measuring unit upstream of and at least one measuring unit downstream of the leakage point.

In the automotive field, water pumps are used whose shafts are sealed relative to the static water pump housing by mechanical shaft seals. FIG. 1 shows such a water pump with a mechanical shaft seal comprising a slide ring 1, a bellows 2, a seal housing 3, a pressure spring 4, a holder 5, a counter ring 6, and a packing 7. The counter ring 6 is secured in the holder 5 together with the packing 7. The holder 5 is fixedly connected to the pump shaft 8 to be sealed. At a spacing from the pump housing 9, a fan wheel 10 is fixedly mounted on the pump shaft. The slide ring 15 1 is forced by the bellows 2 and the pressure spring 4 seal-tightly against the counter ring 6. A sealing gap 11 that is more or less large is formed between the slide ring 1 and the counter ring 6. This sealing gap 11 is typically filled with a mixture of water and cooling agent/antifreeze contained in the cooling system. This medium is required in the sealing gap 11 for the sliding partners 1, 6 to be cooled in operation and for friction to be minimized. Since during operation of a motor vehicle as a result of the generated heat the mixture in the sealing gap 11 will partially evaporate, an average vapor emission of the mechanical shaft seal up to a quantity of 300 mg/h is tolerated in the automobile industry. An excessive loss of the mixture reduces the cooling performance of the cooling system and increases thus the risk of the motor being damaged. The loss of cooling medium also causes environmental pollution. In order to keep the cooling medium loss as minimal as possible, maintenance expenditures would be required leading to costs for the operator.

For this reason, the amount of vapor emission must be measured. This is done by measuring the humidity contained in the air. A known testing device for this purpose is shown in FIG. 3. The mechanical shaft seal 12 to be tested is seated on a pump shaft 8 that is driven in rotation by electric motor 13. The testing device has a testing head 14 in which the medium 15 to be sealed is contained. The shaft 8 projects through a cover 16 that is provided on the testing head 14 and covers the slide ring 12. For testing the vapor emission of the mechanical shaft seal 12, a reference flow 17 is passed by means of the pump through a condenser 18. Moreover, reference air 17 together with the vapor emission 19 that occurs within the mechanical shaft seal 12 is supplied to a further condenser 12 by means of the pump. In the condensers 18, 20, the reference air 17 and the mixture 17, 19 of reference air and vapor emission are cooled. Cooling of the condensers 18, 20 is realized by Peltier elements. As a result of the cooling action, the air can hold less water so that water will condense as a condensate in the condenser 18, 20. It drains from the condenser 18, 20 and is collected in containers 21, 22 installed underneath. The condensate quantities can be weighed after completion of the test and the quantity of the condensate originating from the reference air 17 can be subtracted from the quantity of the condensate originating from the mixture 17, 19. The difference provides the leakage quantity that is a measure for the vapor emission of the mechanical shaft seal 12.

As shown in FIG. 2, the water pump housing 9 has a supply air bore 25 for the measurement. Compressed air is supplied to the leakage point by means of this bore. Diametrically opposite a further bore 23 is provided through which the air can exit downstream of the leakage point at the mechanical shaft seal. The measuring gas flow is supplied through the bore 25. The measuring gas flows annularly about the shaft 8 and along the seal 12. The measuring gas flow is then conducted through the bore 23 away from the leakage point. The liquid leakage flows downwardly into container 24.

FIG. 2 shows two possibilities for guiding the measuring gas. In the embodiment to the left, the bore 25 is arranged vertically. The bore 23 has a branch bore 23′ that is aligned with the bore 25 and connected to the container 24. By means of the bore 23′, the liquid leakage reaches the container 24. The measuring gas flow is conducted further in the bore 23.

In the embodiment to the right in FIG. 2, the bores 23, 25 are horizontally arranged while the bore 23′ extending to the container 24 extends downwardly in the area between the bores 23, 25.

This measuring system with the condensers 18, 20 has the disadvantage that changing ambient conditions, such as ambient temperature or the ambient humidity, change the capability of the condenser to generate a sufficient quantity of condensate. The cooling performance provided by the Peltier elements of the condensers cannot adjust to the changing ambient conditions. The measurement precision is affected by the condensate that does not drain within the condenser 18, 20 and must be blown out by compressed air into the containers 20, 21. Moreover, the measuring duration must be at least 24 hours in order to achieve a measurable result. In regard to optimization and development of mechanical shaft seals, it is particular disadvantageous that for such a long-term measurement no information can be provided in regard to the course of the leakage generation. It cannot be determined whether the leakage quantity has been generated uniformly across the measuring time or whether the leakage quantity has changed during the measuring time.

### SUMMARY OF THE INVENTION

It is an object of the invention to configure a testing device of the aforementioned kind in such a way that a leakage point can be tested in a simple way reliably with regard to the leakage loss.

This object is solved for the testing device of the aforementioned kind by the present invention in that the two measuring units are connected serially, wherein the measuring unit upstream of the leakage point determines measured values of a reference stream and the measuring unit downstream of the leakage point determines measured values of the reference stream plus a vapor emission of the leakage point.

In the testing device according to the invention, the two measuring units are connected serially. One measuring unit is located upstream and the other measuring unit is positioned downstream of the leakage point to be tested. The measuring unit upstream of the leakage point provides a characteristic measured value of the reference flow while the measuring unit downstream of the leakage point provides a characteristic measured value of the mixture of reference flow and vapor emission of the leakage point. A comparison of the measured values of the two measuring units provides a measure of the vapor emission of the leakage point. The two measuring units advantageously provide the measured values continuously so that the leakage generation over time can be determined precisely. In this way, precise statements can be made in regard to whether leakage at the leakage point occurs uniformly or irregularly during the measuring time.

### BRIEF DESCRIPTION OF THE DRAWING

FIG. 1 shows in a schematic illustration and in axial section one half of a mechanical shaft seal mounted on a shaft of a water pump in accordance with the prior art.

FIGS. 2a and 2b show in a section taken along section line II-II of FIG. 1 two embodiments of water pumps.

FIG. 3 shows in a schematic illustration a testing device for detecting vapor emission according to the prior art.

FIG. 4 shows in a schematic illustration a testing device according to the invention for detecting the vapor emission.

FIG. 5 shows in a schematic illustration the components of the testing device according to FIG. 4.

### DESCRIPTION OF THE PREFERRED EMBODIMENTS

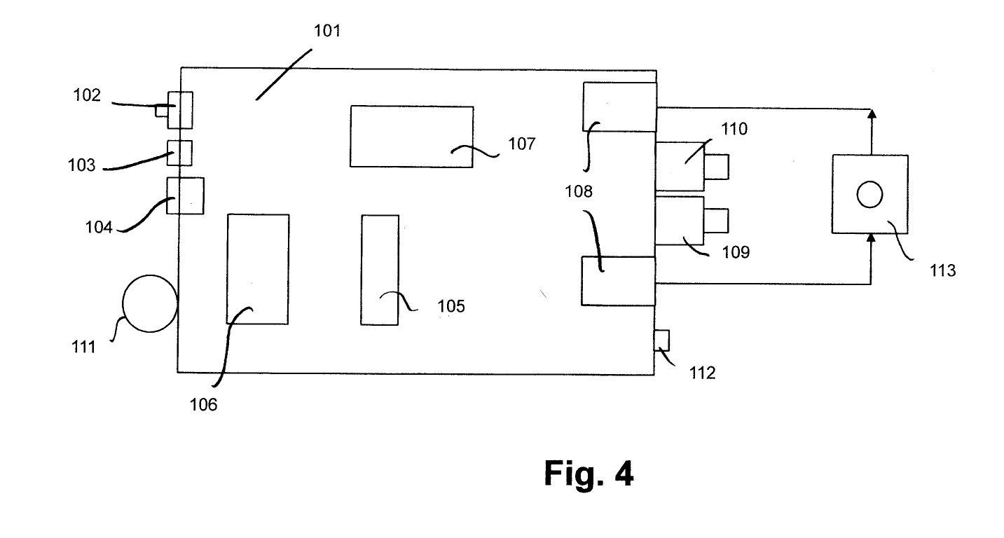

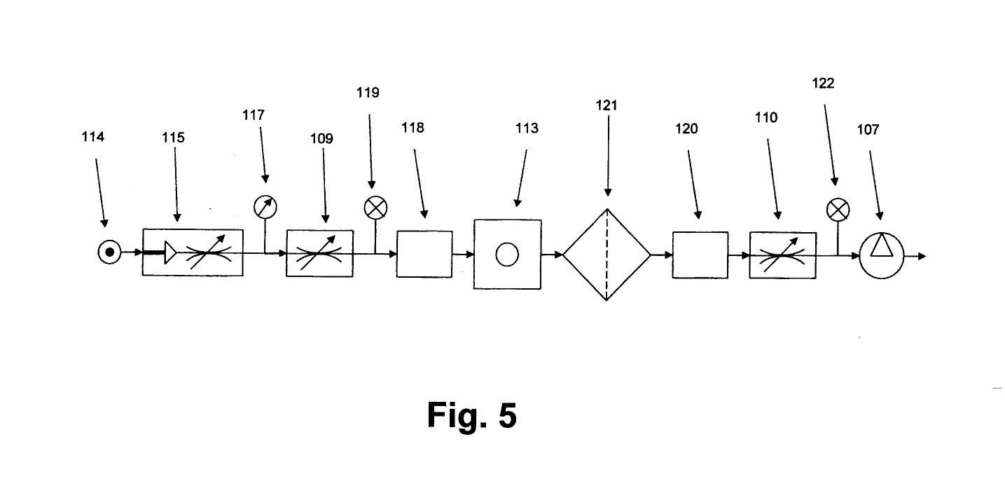

By means of the testing device according to FIGS. 4 and 5, the vapor emission, preferably of mechanical shaft seals, particularly in the automotive field, can be reliably and precisely detected. The testing device is characterized by a simple measuring configuration, can be produced inexpensively, and has a satisfactory measuring range as well as a satisfactorily high measuring precision. The testing device allows advantageously for mobile use and enables a continuous measurement of the vapor emission. It is also possible to perform online measurement with the testing device. Measuring the vapor emission can be done with high precision independent of ambient conditions such as temperature, ambient humidity, and the like. Since a mechanical shaft seal can also be subject to liquid leakage, the testing device is designed such that by means of it the liquid leakage and the vapor leakage can be measured separately.

The testing device has a housing 101 that comprises a mains supply 102 that is advantageously provided with a switch. On the same side of the housing 101 there are two plugs 103,104 for measuring cells with which the ambient humidity (e.g. by means of a humidity sensor) as well as the temperature (e.g. by means of a thermocouple) can be measured. In the housing 101 there is an electric power supply 105, a strip terminal 106, a pump 107, and two sensor receptacles 108. On the exterior of the housing 101 there are two flow rate measuring devices (flow rate meters) 109, 110 with which the supplied and the exiting air quantities are measured in a way to be described in the following.

On the housing 101 there is a holder 114 for a filter, preferably an activated carbon filter. Moreover, the housing 101 is provided with a compressed air connector 112.

The testing device with the housing 101 is of a compact configuration and contains all components required for the testing process that will be described in the following. With this testing device, it is possible without problems to perform a test on site.

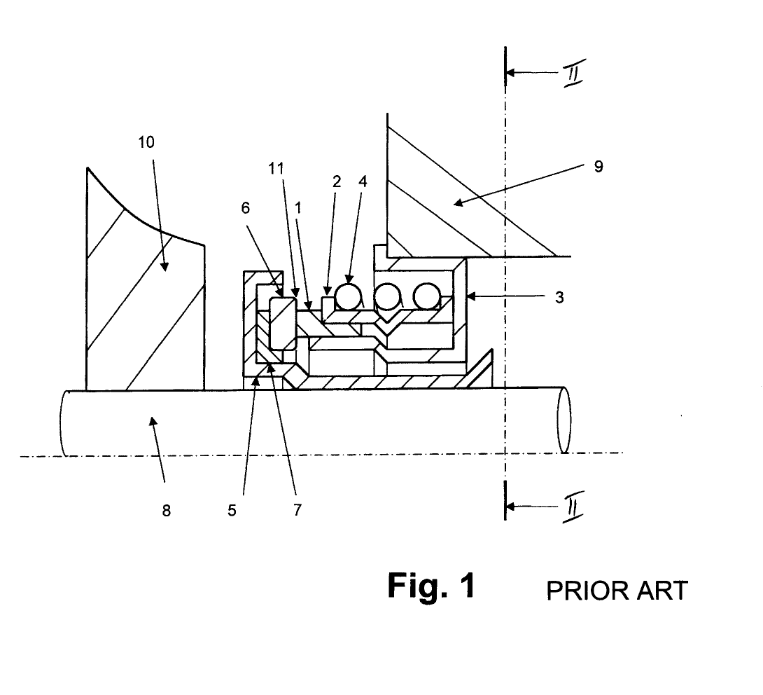

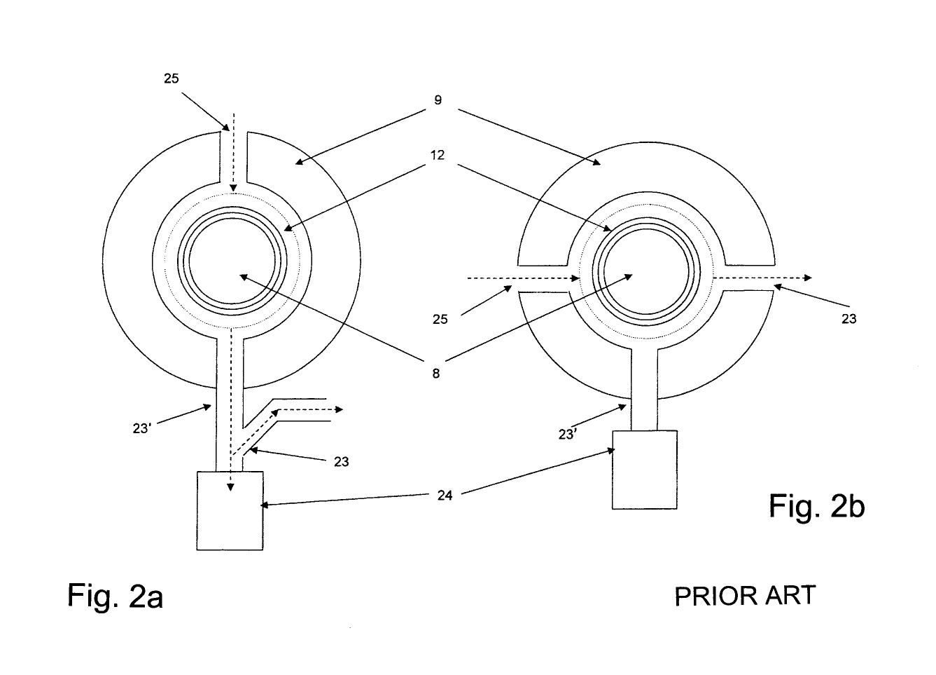

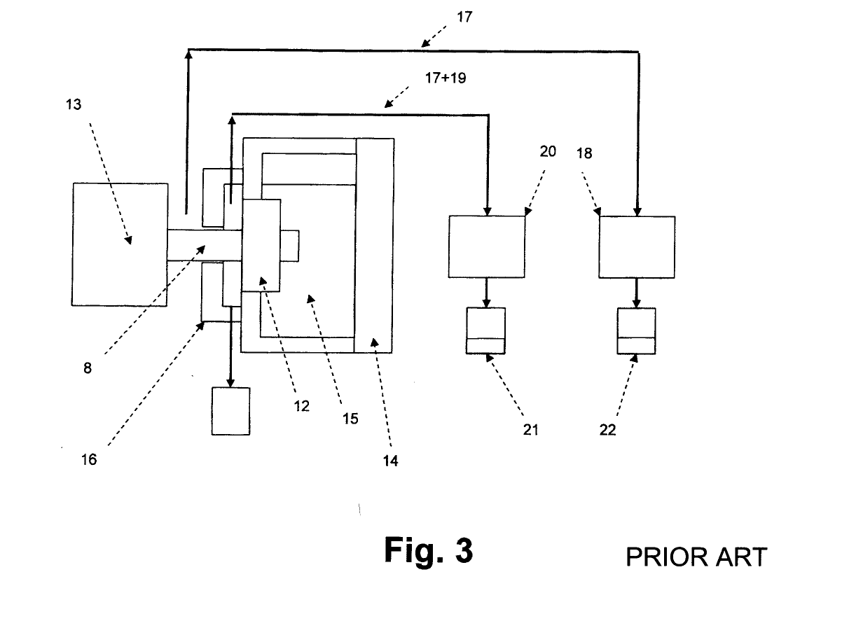

With the aid of FIG. 5, the testing method to be performed with the testing device will be explained in detail. Reference numeral 113 indicates the leakage point of the mechanical shaft seal where a vapor emission occurs, as explained in connection with FIGS. 1 through 3. A compressed air source 114 that is connected to the compressed air connector 112 of the housing 101 generates a compressed air stream that is guided in the direction toward the leakage point 113. The compressed air originating at the compressed air source 114 reaches first the pressure regulator 115 with which the pressure of the compressed air is reduced to an acceptable level. The compressed air then reaches the flow rate measuring device (flow rate meter) 109 that is located in the flow direction of the compressed air upstream of the leakage point 113. In the compressed air conduit 116 between the pressure regulator 115 and the flow rate measuring device (flow rate meter) 109, a pressure gauge 117 is provided with which the pressure of the compressed air is measured before entering the flow rate measuring device (flow rate meter) 109. Should the pressure be too high, a corresponding signal can be sent to the pressure regulator 115 in order to reduce the pressure appropriately. However, it is also possible to interrupt by means of this signal the supply of compressed air to the flow rate measuring device (flow rate meter) 109.

Downstream of the flow rate measuring device (flow rate meter) 109, there is a first humidity/temperature sensor (humidity sensor/thermocouple) 118 that measures the ambient humidity and temperature of the incoming air upstream of the leakage point 113. The values measured by means of this sensor 118 are reference values for the measuring process.

In the area between the flow rate measuring device (flow rate meter) 109 and the sensor 118, a display 119 is provided that indicates proper flow of the compressed air from the flow rate measuring device 109 to the sensor 118. Preferably, the display 119 is part of the flow rate measuring device 109 and, deviating from the illustrated embodiment, can also be provided downstream of the sensor 118.

In the flow direction downstream of the leakage point 113, a second sensor 120 is provided with which the ambient humidity and the temperature of the airflow exiting from the leakage point 113 is determined. In order to protect the second sensor 120 from negative effects of components of the measuring gas that could alter the measured results, the sensor 120 has at least one filter 121, preferably an activated carbon filter, arranged upstream thereof. When, as shown in the illustrated embodiment, the mechanical shaft seal of a water pump is tested with regard to leakage, it is possible that glycol is contained in the air that is escaping from the leakage point 113; glycol is then retained reliably in the filter 121. The air escaping from the leakage point 113 is comprised proportionately of the compressed air coming in from the compressed air source 14 and of the vapor emission. Accordingly, the sensor 120 detects the ambient humidity and the temperature of this mixture.

In order to be within an optimal working range of the filter 121, advantageously preconditioned compressed air, i.e., de-oiled and dried compressed air, is used as the supply gas.

The flow rate measuring device 110 is arranged downstream of the sensor 120; this measuring device, like the flow rate measuring device 109, can be used to regulate the quantity of air. For example, if the seal-tightness of individual system components, in particular of the water pump, cannot be ensured, it is important that a higher amount of supply air relative to exiting air is selected in order to prevent, by means of a minimal overpressure in the system, the ambient air from penetrating. By means of the two flow rate measuring devices 109,110 this can be done without problems in that the devices are adjusted such that the flow rate measuring device 109 allows a greater quantity of compressed air to flow to the leakage point 113. Because by means of the compressed air relative humidity in the ranges between approximately 5% and approximately 25% is to be measured, incoming ambient air would significantly falsify the result.

The flow rate measuring device 110 has also a display 122 correlated therewith that indicates whether the compressed air flows through the flow rate measuring device 110. The display 122 is advantageously part of the flow rate measuring device 110. It can be arranged also in the area between the leakage point 113 and the flow rate measuring device 110.

The two sensors 118, 120 are arranged within the sensor receptacle 108. The sensor 118 is located in the lower sensor receptacle 108 of FIG. 4; in the flow direction it is arranged upstream of the leakage point 113. In the upper sensor receptacle 108 of FIG. 4, the sensor 120 is arranged that is downstream of the leakage point 113.

The pump 107 is advantageously switched only once the seal-tightness of the system components, in particular of the water pump, is not guaranteed. In this case, the compressed air source 114 generates pressure while the pump 107 takes in the compressed air. In this way, only minimal air escapes at the leakage point of the entire system. In contrast, when the entire system is seal-tight, the pump 107 must not be switch on; it is then sufficient to supply the compressed air by means of the compressed air source 114.

In a simpler embodiment, the second flow rate measuring device 110 downstream of the leakage point 113 is not provided. This is possible when the flow rate of the compressed air through the testing device is considered to be constant.

The humidity quantity in the exiting air can be calculated according to the equation
p·V=m·R·T

From this equation it results that

$$m = \frac{p \cdot V}{R \cdot T}$$

The respective pressure can be determined according to
p=rH·pₛ

In this connection, rH stands for relative humidity and pₛ stands for saturation/vapor pressure.

Based on the last equation, the humidity quantity can be determined as follows:

$$m = \frac{rH \cdot {p}_{s} \cdot V}{R \cdot T}$$

The saturation/vapor pressure pₛ is temperature dependent. Accordingly, temperature values T can be correlated in a table with corresponding saturation/vapor pressure values pₛ.

With the described testing device it is possible in a simple and yet precise way to determine the quantity of the vapor emission by means of the described differential measurement of the humidity contained in the compressed air. The measured values determined by the two sensors 118, 120 are advantageously supplied to a computer (not illustrated) that, based on the comparison of the determined values, can reliably determine the humidity quantity and thus the vapor emission. By means of the flow rate measuring devices 109, 110, the flow rate quantity can be optimally controlled so that a very precise measurement is ensured.

The testing device is used advantageously for measuring leakage of mechanical shaft seals in the automotive field. For example, it is also possible to measure by means of the testing device the humidity in an atmosphere that contains e.g. organic or inorganic components.

The specification incorporates by reference the entire disclosure of German priority document 10 2006 008 463.2 having a filing date of Feb. 17, 2006.

While specific embodiments of the invention have been shown and described in detail to illustrate the inventive principles, it will be understood that the invention may be embodied otherwise without departing from such principles.

What is claimed is:

1. A testing device for detecting vapor emission of at least one leakage point, the testing device comprising:
at least one upstream measuring unit arranged upstream of a leakage point and at least one downstream measuring unit arranged downstream of the leakage point;
wherein the at least one upstream and the at least one downstream measuring units are connected serially;
wherein the at least one upstream measuring unit determines measured values of a reference stream and the at least one downstream measuring unit determines measured values of the reference stream plus a vapor emission of the leakage point.

2. The testing device according to claim 1, further comprising a computer, wherein the measured values of the at least one upstream and the at least one downstream measuring units are supplied to a computer.

3. The testing device according to claim 1, wherein the at least one upstream and the at least one downstream measuring units measure at least one of a relative humidity of the reference stream and a temperature of the reference stream.

4. The testing device according to claim 1, further comprising a flow rate meter arranged upstream of or downstream of the at least one upstream measuring unit.

5. The testing device according to claim 1, further comprising a flow rate meter arranged upstream or downstream of the at least one downstream measuring unit.

6. The testing device according to claim 1, wherein the reference stream is a compressed air stream.

7. The testing device according to claim 1, wherein the testing device has at least one compressed air connector connectable to a compressed air source.

8. The testing device according to claim 7, further comprising a pressure regulator arranged upstream of the at least one upstream measuring unit.

9. The testing device according to claim 8, wherein the pressure regulator is arranged between the compressed air source and the at least one upstream measuring unit.

10. The testing device according to claim 1, further comprising a filter arranged upstream of the at least one upstream measuring unit or the at least one downstream measuring unit.

11. The testing device according to claim 1, further comprising a pump.

12. The testing device according to claim 1, wherein the at least one upstream and the at least one downstream measuring units each have a humidity sensor and a thermocouple.

13. The testing device according to claim 1, connected to a mechanical shaft seal.
